(19) United States
(12) Patent Application Publication
(10) Pub. No.: US 2025/0178857 A1
(43) Pub. Date: Jun. 5, 2025

(54) SWIVEL DRIVE FOR A WINDING DEVICE

(71) Applicant: SSM Schärer Schweiter Mettler AG, Wädenswil (CH)

(72) Inventors: Martin KÜTTEL, Gattikon (CH); André WANDELER, Samstagern (CH)

(21) Appl. No.: 18/840,614

(22) PCT Filed: Feb. 24, 2023
(86) PCT No.: PCT/EP2023/054674

§ 371 Date: Aug. 22, 2024

(30) Foreign Application Priority Data
Feb. 25, 2022 (CH) 000186/2022

(51) Int. Cl. B65H 54/74; B65H 54/44; B65H 54/52; B65H 63/08

(52) U.S. Cl. CPC B65H 54/74; B65H 54/44; B65H 54/52; B65H 63/08; B65H 2701/31

(57) ABSTRACT

A swivel drive for a winding device wherein a thread is wound onto a bobbin tube to form a bobbin includes a swivel axis. A motor is coupled with a drive shaft, wherein the drive shaft has a drive axis. A first gear stage is coupled to the drive shaft, and a second gear stage is coupled to the first gear stage. The second gear stage has a gear output oriented in the swivel axis. The first gear stage includes a first crown gear and the second gear stage includes a second crown gear.

### RELATED APPLICATIONS

The present application claims priority to PCT Application Number PCT/EP2023/054674, filed Feb. 24, 2023, which claims priority to CH Application No. 000186/2022, filed Feb. 25, 2022. Both applications are incorporated by reference herein in their entirety.

### FIELD OF THE INVENTION

The present invention relates to a swivel drive for a winding device for winding a thread onto a bobbin tube to form a bobbin, and with a machine frame and a winding mandrel for holding the bobbin tube, wherein the winding mandrel is held on a swivel lever, which is rotatably mounted on a rotary axis in the machine frame.

### BACKGROUND

Generic swivel drives are used in textile machines of various types, for example end spinning machines, rewinding machines, or winding machines. The bobbin or the bobbin tube is rotatably mounted between two holding arms or on a winding mandrel. The two holding arms or the winding mandrel are in turn held in a common swivel arm using a swivel axis. At the beginning of a winding process (a so-called winding cycle), the bobbin tube abuts against a support roller and is set in rotation by a drive, whereby a thread or yarn fed between the support roller and the bobbin tube is wound onto the bobbin tube and a bobbin is formed. Various types of bobbin tubes in cylindrical or conical shape made of different materials, for example plastics material or paper, are used. The bobbin tubes can be designed with or without side flanges. Depending on the bobbin tube used, embodiments of the support roller are also known with which the support roller is moved along its axis during a winding process in order to adapt to the design of the bobbin tube. During winding, the yarn is moved back and forth with a traverse along a longitudinal axis of the bobbin tube, whereby different types of windings are formed in structure and shape. The bobbin tube is driven directly via a motor, which sets at least one of the tube receptacles or the bobbin mandrel in rotation, or indirectly via a friction roller arranged parallel to the bobbin tube. The friction roller simultaneously serves as a support roller. The friction roller can be designed as a so-called grooved drum or slotted drum. In the case of a direct drive of the bobbin tube, the traverse of the thread is provided by a separate laying unit and a support of the bobbin tube is provided by a separate support roller. The yarn is clamped between the support roller and the bobbin tube or the yarn already on the bobbin tube and is thereby deposited on the bobbin tube.

As a result of the winding process, a diameter of the resulting bobbin increases steadily due to the thread wound onto the bobbin tube. As a result, the distance between the support roller and the longitudinal axis of the bobbin tube increases. Winding devices are known from the prior art which are equipped with a swivel drive for this movement. It is also known that swivel drives can be equipped with an angle measurement, whereby a corresponding controller always knows in which position the swivel drive or the bobbin tube is located.

CN 206 692 118 U discloses a swivel drive with which the swivel axis is driven indirectly by a motor. The movement of the motor is transmitted to the swivel arm via a belt drive. In contrast, EP 3 649 069 A1, for example, discloses a swivel drive that provides a direct drive of the swivel axis. An electric motor is coupled to the swivel axis via a planetary spiral gearbox. The disadvantage of this is that the self-locking of the drive must be overcome or the swiveling must take place by means of the drive itself in order to remove a full bobbin.

Also known are winding devices in which the swivel drive does not have its own drive, whereby the bobbin tube is pivoted about the swivel axis solely by increasing the bobbin diameter during a winding cycle. For example, EP 1 820 764 A2 discloses such a winding device. In order to achieve a uniform movement of the swivel arm, the bobbin tube and the bobbin are pressed against the grooved drum with a pneumatic cylinder. In an alternative solution, DE 198 17 363 A1 or U.S. Pat. No. 6,405,968 B2, for example, disclose a regulation of a contact pressure between the grooved drum and the bobbin by applying a torque by means of a drive of the swivel axis via a stepper motor, wherein a swiveling movement of the swivel arm is effected by the bobbin itself growing in diameter.

Another disadvantage of the known embodiments of the known swivel drives is also that, for one thing, their design leads to limited repeatability in direct drives due to their self-locking, or elasticity in belt drives.

### SUMMARY OF THE INVENTION

It is therefore an object of the present invention to propose a swivel drive for a winding device for winding a thread onto a bobbin tube, which enables precise movement due to its zero backlash. Additional objects and advantages of the invention will be set forth in part in the following description or may be obvious from the description or may be learned through practice of the invention.

The object is achieved by a device and a method having the features described and enabled herein.

A swivel drive for a winding device for winding a thread onto a bobbin tube to form a bobbin is proposed, wherein the swivel drive has a drive axis and a swivel axis and a motor arranged in the drive axis and a first gear stage and a second gear stage with a gear output in the swivel axis, wherein in each case a crown gear is provided in both gear stages. In terms of their construction, gearboxes with crown gears are angular gearboxes. A high degree of efficiency of over 90% can be achieved with crown gear gearboxes. With a crown gear gearbox, the crown gear works together with a cylinder gear, whereby high reduction ratios can be achieved. Corresponding toothing also makes it possible to transmit the rotation of the crown gear to the cylinder gear and vice versa without backlash. For example, spur or helical toothings are used for the cylinder gear. In addition to zero backlash, their construction means that crown gear gearboxes are not sensitive to slight angular displacements. This has the advantage that vibrations, which can be transmitted from the winding device to the swivel drive, have no influence on the operational safety of the gear stages.

Preferably, a connection between the motor and the first crown gear of the first gear stage is provided via a first pinion, wherein the first pinion is connected to a rotor of the motor in a rotationally secured manner. Together with the first crown gear, the first pinion forms the first gear stage. A pinion is a toothed cylindrical gear with an axis firmly attached to it. The axis and cylinder gear can also be in one piece. The toothing of the cylinder gear can be provided as straight, helical-curved or angular toothing. As a result of interposing the pinion, a high first reduction ratio of up to 1 to 10 is achieved between the motor and the first crown gear. A second crown gear and an associated second pinion are also provided in the second gear stage. A reduction ratio of up to 1 to 10 can also be achieved in the second gear stage. As a result of the connection of the first gear stage with the second gear stage, a reduction ratio of up to 1 to 100 arises for the proposed swivel drive. A reduction ratio of 1 to 90, for example, results in half a rotation of the motor for one rotation around a swivel axis by 2 angular degrees. It has been found that a total reduction ratio in the range of 1 to 16 to 1 to 64 is preferable for the operation of a winding device. As a result, very fine changes to the position of the swivel axis are possible.

Advantageously, the crown gears of the first gear stage and the second gear stage are operatively connected via a second pinion, wherein the first crown gear of the first gear stage and the second pinion of the second gear stage are connected via a common axis. A first crown gear is driven via the first cylinder gear of the first pinion. The first pinion and the first crown gear form the first gear stage. As a result of the fact that the first crown gear is held in a rotationally fixed manner on an axis shared with a second pinion, the first crown gear and the second cylinder gear have the same rotational speed. As a result of the simple design, a common axis is achieved. A clutch can be provided between the second pinion and the first crown gear. This has the advantage that the two gear stages can be built separately or even replaced. For the purposes of this patent application, the axes of the first crown gear and of the second pinion, which are locked via a clutch, are regarded as a common axis. The second crown gear is now driven via this second pinion or the second cylinder gear. One axis of the second crown gear is an output shaft of the swivel drive. A swivel axis of a corresponding winding device can be connected to the axis of the second crown gear.

Preferably, the motor has an angle measurement. With the angle measurement of the motor, an exact position of the swivel axis can be ascertained after a conversion via the gear stages. A controller can use the position of the swivel axis to calculate the diameter of the bobbin and the time required to complete a bobbin. Alternatively, an angle measurement can also be provided directly on the swivel axis, but this is less accurate, since the swivel axis is only rotated for a few angular minutes at a time, corresponding to the increasing diameter of the bobbin.

A winding device for winding a thread onto a bobbin tube is also proposed. The winding device has at least one swivel arm with a swivel axis and a tube receptacle arranged on the swivel arm and a support roller for abutting the bobbin tube, wherein a swivel drive is provided for moving the swivel arm about the swivel axis according to the previous description. The tube receptacle can be designed in the form of a bobbin mandrel. Simple rotating support rollers or driven friction rollers and grooved drums are used as support rollers. In a preferred embodiment, a drive for the winding mandrel is arranged on the first lever arm. The additional weight of this drive, which also influences the abutment force of the bobbin tube on the support roller, can be absorbed by the corresponding movement of the swivel drive. As a result of this direct drive of the winding mandrel instead of an indirect drive of the bobbin with the aid of the support roller, a slip-free control of the winding speed is possible. There are also fewer losses in the form of friction and mechanical transmission, which leads to lower energy consumption by the bobbin drive.

Advantageously, a controller is provided, wherein an input of a yarn count is provided in the controller. If the yarn count is known to the controller, the controller can calculate the necessary movement of the swivel arm during a winding cycle. After a winding is placed on the bobbin, the swivel arm is pivoted by the yarn count. A completion of a winding is known to the controller due to the revolutions of the bobbin and a traverse of the thread.

Preferably, a force measurement device is provided for ascertaining the abutment force acting on the swivel arm. With the aid of the force measurement device, a quantity is determined which, taking into account the technical conditions of the machine, is directly proportional to the abutment force of the bobbin tube or the bobbin on the support roller. It is not the abutment force between the bobbin or bobbin tube and the support roller that is measured directly, but the force acting on the swivel arm. A dead weight of the swivel arm together with any existing drive for the winding mandrel and the winding mandrel itself must be taken into account in terms of their influence on the force measurement device. The resulting forces acting on the force measurement device change as the diameter of the bobbin increases due to the swiveling movement of the swivel arm and an associated change in the horizontal distance between the winding mandrel and the stationary rotary axis of the swivel arm.

The force measurement device can be designed as a hydraulic or mechanical force measurement device. The force measurement device is advantageously designed as a load cell arranged between two parts of the swivel arm. This allows for a simple and compact design, and a load cell can also be coupled directly to a controller in a simple manner. Various types of so-called force transducers can be used in load cells. For example, the use of force transducers is known in which the force acts on a resilient spring body and deforms it. The deformation of the spring body is converted into a change in electrical voltage by means of strain gages, the electrical resistance of which changes with the strain. The electrical voltage and thus the change in strain are registered via a measuring amplifier. This can be converted into a force measurement value due to the resilient properties of the spring body. Bending bars, ring torsion springs, or other designs are used as spring bodies. Piezoceramic elements are used in a further type of load cell. The directional deformation of a piezoelectric material creates microscopic dipoles within the elementary cells of the piezoelectric crystal. The summation of the associated electrical field in all unit cells of the crystal leads to a macroscopically measurable electrical voltage, which can be converted into a force measurement value. Load cells are known from the prior art and are now widely used in force and weight measurement devices. As an alternative to the arrangement of the force measurement device in the swivel arm, a force measurement can be carried out directly above the axis of the swivel arm. In this case, the axis is also designed to function as a swiveling connection between the holder and the swivel arm as a force-introducing component of a force measurement.

Advantageously, the controller determines a movement of the swivel arm about the swivel axis based on the force measurement, such that the abutment force of the bobbin on the support roller is constant. As a result of the constant pressure conditions during the winding process, an exact calculation of the thread length wound out is possible. Based on the constant abutment force, a uniform bobbin density is achieved over the entire winding cycle, resulting in a constant ratio of yarn count to bobbin diameter.

Preferably, two swivel arms are provided with a common swivel axis and with tube receptacles arranged on each swivel arm and with a support roller for abutting the bobbin tube. As a result, the advantage arises that larger bobbins can be produced, since, due to the double-sided bearing of the bobbin tube, a force distribution to two swivel arms takes place and the bobbin runs more smoothly.

A winding machine or a rewinding machine is preferably equipped with a winding device as described above, which makes the machine itself easy to operate and inexpensive to manufacture. When a specified bobbin diameter is reached, winding is stopped and the bobbin is lifted off the support roller by the swivel drive. The specified bobbin diameter can be determined in various ways. The length of the wound thread can be determined or calculated via the winding speed and thus the current bobbin diameter can be inferred. Furthermore, it is also possible to detect the deflection of the swivel lever by means of sensors and to deduce the bobbin diameter therefrom. The term “a specified bobbin diameter is reached” can thus also be understood as the specification of a specific thread length, duration of a winding or degree of swiveling of the swivel arm. If the bobbin has been lifted off, it can be removed from the bobbin mandrel manually and/or with the aid of an automatic removal device after, or rather, during the manual or automatic release of the clamping device of the winding mandrel. In the raised state, the final weight of the finished bobbin can be determined by means of the force measurement device.

### BRIEF DESCRIPTION OF THE DRAWINGS

Further advantages of the invention are described in the following exemplary embodiment. In the figures:

FIG. 1 shows a schematic top view of a first embodiment of a winding device according to the invention;

FIG. 2 shows a schematic side view of the winding device in the direction X according to FIG. 1;

FIG. 3 shows a schematic representation of an embodiment of a swivel drive; and

FIG. 4 shows a schematic top view of a second embodiment of a winding device according to the invention.

### DETAILED DESCRIPTION

Reference will now be made to embodiments of the invention, one or more examples of which are shown in the drawings. Each embodiment is provided by way of explanation of the invention, and not as a limitation of the invention. For example features illustrated or described as part of one embodiment can be combined with another embodiment to yield still another embodiment. It is intended that the present invention include these and other modifications and variations to the embodiments described herein.

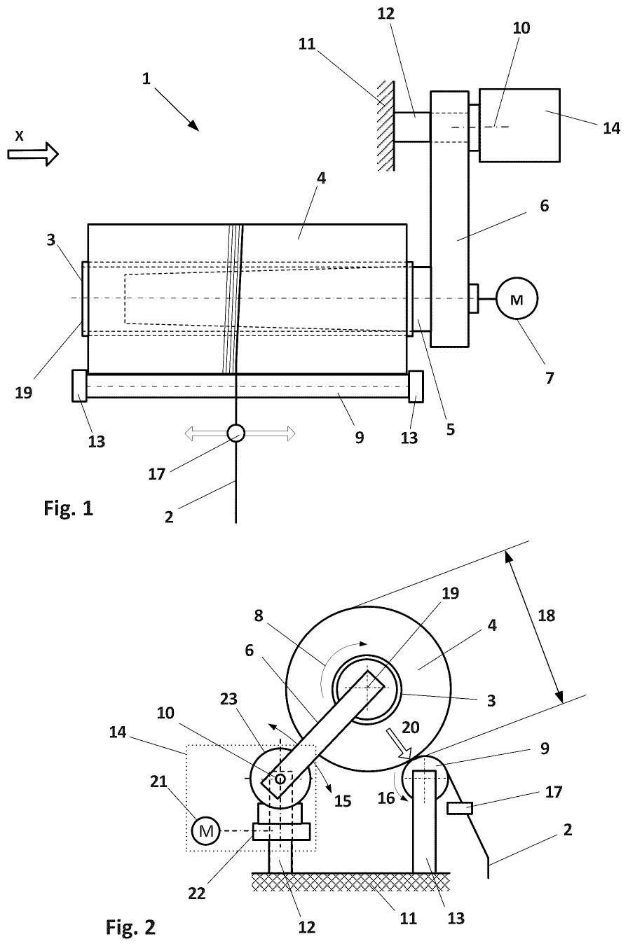

FIG. 1 shows a schematic top view and FIG. 2 shows a schematic side view in the direction X of FIG. 1 of a first embodiment of a winding device 1 for winding a thread 2 or a yarn onto a bobbin tube 3 to form a bobbin 4. The winding device 1 comprises a tube receptacle 5 that is rotatably mounted on a swivel arm 6. In the embodiment shown, the tube receptacle 5 is set in rotation by a bobbin drive 7, which is also held on the swivel arm 6. The bobbin tube 3 is held in a rotationally fixed manner in the tube receptacle 5 with the aid of a clamping device (not shown), so that the bobbin tube 3 and thus the bobbin 4 located on the tube receptacle 5 are also set in rotation 8 via the tube receptacle 5. During a winding process, the bobbin tube 3 or the bobbin 4 is supported on a support roller 9. An alternative to the drive form described above would be a friction drive of the bobbin tube 3 or the bobbin 4 via a driven support roller 3. The swivel arm 6 is held fixedly in a swivel axis 10 on a machine frame 11 by a corresponding support 12 and is rotatably mounted. The tube receptacle 5 with the associated winding drive 7 is attached to one end of the swivel arm 6 opposite the swivel axis 10. In the embodiment shown, the support roller 9 is held rotatably in supports 13 in the machine frame 11. The support roller 9 is arranged with its axis parallel to an outer surface of the bobbin tube 3 or the bobbin 4. The swivel arm 6 is rotated about the swivel axis 10 by a swivel drive 14, which results in the distance between the bobbin tube 3 and the support roller 9 being changed. The bobbin tube 3 comes to abut against the support roller 9 based on a swiveling movement 15 of the swivel arm 6 about the swivel axis 10 during a winding process. As a result of rotating 8 the bobbin tube 3 in a corresponding direction of rotation, a thread 2 placed on the bobbin tube 3 is wound onto the bobbin tube 3 and a bobbin 4 is formed. In this case, the support roller 9 is also set in rotation in the corresponding direction of rotation 16 by abutting the bobbin 4 against the support roller 9. During this winding process, the so-called winding cycle, the thread 2 is moved back and forth along a bobbin axis of the bobbin tube 3 with a traverse 17. With the aid of this direction of movement of the traverse 17, different types of windings or bobbins 4 can be produced on the bobbin tube 3. As a result of the formation of a winding on the bobbin tube 3, the diameter 18 of the bobbin 4 increases, whereby the tube receptacle 5 and thus the swivel arm 6 is pivoted about the swivel axis 10, away from the support roller 9 based on the abutment against the support roller 9.

During the winding process, the thread 2 is clamped between the bobbin tube 3 or the thread 2 already wound onto the bobbin tube 3 and the support roller 9, so that it results in a tight-fitting winding on the bobbin tube 3. A clamping force or abutment force 20 applied in the process increases continuously during a winding process due to the dead weight of the increasing bobbin 4.

In order to ensure a constant abutment force 20, the swivel drive 14 moves the swivel arm 6 about the swivel axis 10, and as a result lifts the bobbin 4 from the support roller 9. However, this lifting is only carried out to the extent that a predetermined abutment force remains between the bobbin 4 and the support roller 9. The swivel drive 14 is connected in a rotationally fixed manner to the swivel arm 6 along the swivel axis 10. The swivel drive 14 comprises a motor 21 and a swivel gearbox consisting of a first gear stage 22 and a second gear stage 23 between the motor 21 and the swivel arm.

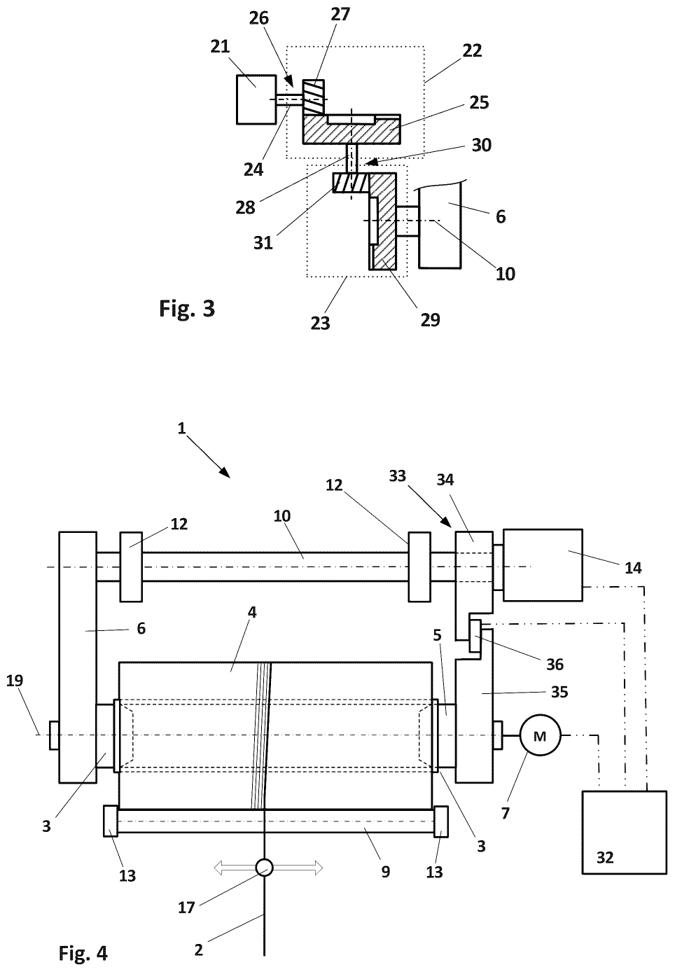

FIG. 3 shows a schematic representation of an embodiment of a swivel drive 14. The swivel drive 14 comprises a motor 21 and a swivel gearbox with a first gear stage 22 and a second gear stage 23. In the first gear stage 22, the motor, or rather its rotor, is connected to a first pinion 26 via a drive axis 24. The first pinion 26 has a first toothed cylinder gear 27 held in a rotationally fixed manner on an axis. The first cylinder gear 27 can also be provided in one piece with its axis and is connected in a rotationally fixed manner to the drive axis 24. The toothing of the first cylinder gear 27 meshes with the toothing of a first crown gear 25 of the first gear stage 22. The 90 degree arrangement of the first pinion 26 to the first crown gear 25 shown is exemplary; other arrangements are also possible depending on the design conditions. The first crown gear 25 of the first gear stage is connected via an axis 28 in common with the second gear stage 23. The common axis 28 connects the first crown gear 25 of the first gear stage 22 with a second pinion 30 of the second gear stage 23. The second pinion 30 has a second toothed cylinder gear 31, which engages with its toothing in a second crown gear 29 or its toothing. The second crown gear 29 of the second gear stage 23 is connected in a rotationally fixed manner to the swivel arm 6 along the swivel axis 10. The type of the swivel gearbox shown is exemplary; for example, additional gear stages can be installed for design reasons or to increase the transmission ratios, or the angular positions of the various axes in relation to one another can be changed.

FIG. 4 shows a schematic top view of a second embodiment of a winding device 1 for winding a thread 2 or a yarn onto a bobbin tube 3 to form a bobbin 4. The winding device 1 comprises two tube receptacles 5, which are opposite one another along a bobbin axis 19 and are each rotatably mounted on a swivel arm 6 and 33. In the embodiment shown, one tube receptacle 5 is set in rotation by a bobbin drive 7 also held on the swivel arm 33. A bobbin tube 3 is inserted between the tube receptacles 5, and the bobbin tube 3 is held in a rotationally fixed manner between the tube receptacles 5 by a clamping device (not shown), so that the bobbin tube 3 and thus the bobbin 4 located on the tube receptacle 5 are also in rotation via the tube receptacle 5 provided on the swivel arm 33. During a winding process, the bobbin tube 3 or the bobbin 4 is supported on a support roller 9. The swivel arms 6 and 33 are held fixedly with a swivel axis 10 on a machine frame by a corresponding support 12 and are rotatably mounted. The tube receptacle 5 with the associated winding drive 7 is attached to one end of the swivel arm 33 opposite the swivel axis 10. The support roller 9 is held rotatably in supports 13 in the machine frame. The support roller 9 is arranged with its axis parallel to an outer surface of the bobbin tube 3 or the bobbin 4. The swivel arms 6 and 33 are rotated together about the swivel axis 10 by a swivel drive 14, which results in the distance between the bobbin tube 3 and the support roller 9 being changed. As a result of the abutment of the bobbin 4 against the support roller 9, the support roller 9 is also set in rotation and the thread 2 is wound onto the bobbin tube 3 to form a bobbin 2. During this winding process, the so-called winding cycle, the thread 2 is moved back and forth along the bobbin axis 19 of the bobbin tube 3 with a traverse 17.

During the winding process, the thread 2 is clamped between the bobbin tube 3 or the thread 2 already wound onto the bobbin tube 3 and the support roller 9, so that it results in a tight-fitting winding on the bobbin tube 3. A clamping force or abutment force 20 (see FIG. 20) applied in the process increases continuously during a winding process due to the dead weight of the increasing bobbin 4. In order to ensure a constant abutment force 20, the swivel drive 14 moves the swivel arm 6 about the swivel axis 10, and as a result lifts the bobbin 4 off the support roller 9. However, this lifting is only carried out to the extent that a predetermined abutment force remains between the bobbin 4 and the support roller 9. The swivel drive 14 is connected in a rotationally fixed manner to the swivel arms 6 and 33 along the swivel axis 10.

To maintain the predetermined abutment force 20, the swivel arm 33 is equipped with a force measurement device 36. The swivel arm 33 is divided into a first partial arm 34 and a second partial arm 35. The force measurement device 36 connects the first partial arm 34 with the second partial arm 35, whereby the bending forces caused by the abutment force 20 in the swivel arm 33 are measured. As a reaction to the abutment force and the lifting of the bobbin 4 by means of the swivel drive 14, there is a change in the force applied to the force measurement device 35. The force measurement device 15 as well as the swivel drive 14 are connected to a controller 32. The force measured with the force measurement device 35 is directly proportional to the abutment force 20 between the bobbin 2 and the support roller 3. The measured forces are evaluated in the controller 32 and compared with the predetermined abutment force. Accordingly, the swivel drive 14 is controlled by the controller 32 and the abutment force 20 is kept at a constant value.

The present invention is not limited to the exemplary embodiments as shown and described. Modifications within the scope of the claims are possible, as well as a combination of the features, even if these are shown and described in different exemplary embodiments.

### LIST OF REFERENCE SIGNS

1 Winding device
2 Thread
3 Bobbin tube
4 Bobbin
5 Tube receptacle
6 Swivel arm
7 Bobbin drive
8 Rotation
9 Support roller
Swivel axis
11 Machine frame
12 Support swivel arm
13 Support support roller
14 Swivel drive
15 Swiveling movement
16 Direction of rotation of the support roller
17 Traverse
18 Bobbin diameter
19 Bobbin axis
20 Abutment force
21 Motor swivel drive
22 First gear stage
23 Second gear stage
24 Drive axis
25 First crown gear
26 First pinion
27 First cylinder gear
28 Common axis
29 Second crown gear
30 Second pinion
31 Second cylinder gear
32 Controller
33 Second swivel arm
34 First partial arm
35 Second partial arm
36 Force measurement device

1-10. canceled

11. A swivel drive configured for a winding device for winding a thread onto a bobbin tube to form a bobbin, the swivel drive comprising:
a swivel axis;
a drive shaft;
a motor coupled with the drive shaft, wherein the drive shaft has a drive axis;
a first gear stage coupled to the drive shaft;
a second gear stage coupled to the first gear stage, the second gear stage having a gear output in the swivel axis; and
the first gear stage comprising a first crown gear and the second gear stage comprising a second crown gear.

12. The swivel drive according to claim 11, wherein the first gear stage comprises a first pinion rotationally driven by the motor and engaged with the first crown gear.

13. The swivel drive according to claim 12, comprising a second pinion coupling the first crown gear to the second crown gear, wherein the first crown gear and the second pinion are connected via a common axis.

14. The swivel drive according to claim 11, wherein the motor is configured with an angle measurement.

15. A winding device for winding a thread onto a bobbin tube in forming a wound bobbin, comprising:
a first swivel arm with a swivel axis;
a tube receptacle arranged on the first swivel arm to receive the bobbin tube;
a support roller configured to abut the bobbin tube and the wound bobbin;
a swivel drive, the swivel drive further comprising:
a swivel axis;
a drive shaft;
a motor coupled with the drive shaft, wherein the drive shaft has a drive axis;
a first gear stage coupled to the drive shaft;
a second gear stage coupled to the first gear stage, the second gear stage having a gear output in the swivel axis; and
the first gear stage comprising a first crown gear and the second gear stage comprising a second crown gear.

16. The winding device according to claim 15, further comprising a controller configured to control the swivel drive according to a yarn count input into the controller.

17. The winding device according to claim 15, further comprising a force measurement device configured to measure an abutment force acting on the first swivel arm from abutment of the wound bobbin against the support roller.

18. The winding device according to claim 17, further comprising a controller in communication with the swivel drive, the controller configured to determine a swiveling movement of the first swiveling arm about the swivel axis based on the abutment force to maintain the abutment force constant.

19. The winding device according to claim 15, further comprising a second swivel arm and a second tube receptacle arranged on the second swivel arm, the swivel axis common to the first and second swivel arms.

20. A winding machine, the winding machine comprising the winding device according to claim 15.
